(19) United States
(12) Patent Application Publication
(10) Pub. No.: US 2014/0100942 A1
(43) Pub. Date: Apr. 10, 2014

(54) SYSTEMS, METHODS AND APPARATUS FOR DISTRIBUTING PRODUCT SAMPLES

(71) Applicant: Zoran Konevic, Markham (CA)

(72) Inventor: Zoran Konevic, Markham (CA)

(21) Appl. No.: 14/118,305

(22) PCT Filed: May 21, 2012
(86) PCT No.: PCT/IB2012/001897

§ 371 Date: Nov. 18, 2013

Related U.S. Application Data
(60) Provisional application No. 61/487,988, filed on May 19, 2011.

(51) Int. Cl. G06Q 30/02

(52) U.S. Cl. CPC G06Q 30/0237
USPC 705/14.37

(57) ABSTRACT

A method of distributing samples to consumers, comprising a kiosk system, a kiosk application and a kiosk. The kiosk system is used to set up the manufacturer and vendor information, to set up a reporting and analytical framework, and to establish communication with the kiosk application and the kiosk. Among other things, the kiosk application is used to locate the kiosk and provide a code to the consumer. The kiosk application may also be used to issue a coupon to the consumer, wherein the consumer redeems the coupon to purchase a variety of the product sample. The kiosk is used to distribute samples. The consumer inputs the code into the kiosk to obtain a sample.

### RELATED APPLICATIONS

This application claims the benefit of and priority to U.S. Provisional Application No. 61/487,988, entitled “TRYAD KIOSK AND TRYAD APPLICATION MANAGER,” which was filed on May 19, 2011. The entire disclosure of the provisional application (U.S. Provisional Application No. 61/487,988) is incorporated herein by reference.

### FIELD OF THE INVENTION

The general inventive concepts relate to distributing product samples and, more particularly, to systems, methods, and apparatus for distributing product samples via kiosks, in conjunction with a mobile application which facilitates said distribution.

### BACKGROUND

Automated retail is a fast-growing model for dispensing products and merchandise. Although earlier forms of automated retail, such as vending machines, gained much popularity, recent trends have been moving towards “smart” automated retail, such as kiosk machines, or simply, kiosks. Kiosks present an improvement over traditional vending machines, by way of providing an enhanced user experience, usually through providing touch screen interfaces and interactive displays. The number and type of products being offered through such kiosks is also growing at a swift pace. However, kiosks have previously not been utilized as part of a product sample distribution system.

Additionally, portable computing devices have become widely adopted in the technology-driven modern world. “Smart” phones (e.g., Apple's iPhone®, Google's Droid®, Research in Motion's Blackberry®) and “Tablet Computers” (e.g. Apple's iPad®) are two types of portable computing devices. While portable computing devices combine the functionality of Personal Digital Assistants (“PDAs”) with the functionality of cellular or mobile phones, Tablet Computers bring most features of personal computing to a portable platform. Along with the advent and the wide-spread acceptance of the portable computing devices, came the need for applications (“apps”) which operate on said devices and perform specific functions as desired by a consumer (or a “user”). However, apps have previously not been utilized as part of a product sample distribution system.

Currently, consumers receive product samples through traditional marketing channels such as magazines and store promotions. Consumers would like to be able to utilize their portable computing devices to obtain products samples, product sample coupons and survey requests. Manufacturers typically face expensive shelf space at retail locations and would like to be able to showcase their products within a controlled environment, provide targeted information to consumers, receive customized and tailored feedback and have an opportunity to data-mine the sample distribution systems. Brand developers would like to be able to use a platform to launch new products and services and reach directly to consumers for feedback through alternative sales, marketing and distribution channels. Vendors would like to have an opportunity to work with manufacturers and consumers through a custom designed application.

Kiosks and apps have not previously been utilized together as part of a product sample distribution system. Therefore, in view of the above, there is an unmet need for systems, methods and apparatuses for a product sample distribution system, which further utilizes an app and one or more kiosks, to enable users to receive product samples, to enable manufacturers to provide targeted product samples, and to allow vendors to facilitate the distribution of product samples.

### BRIEF SUMMARY

The general inventive concepts contemplate systems, methods, and apparatuses for distributing product samples. By way of example, to illustrate various aspects of the general inventive concepts, several exemplary embodiments of systems methods and/or apparatuses are disclosed herein.

Systems, methods, and apparatuses, according to one exemplary embodiment, provide a method of distributing samples, comprising a kiosk system, a kiosk application and a kiosk. The kiosk system enables manufacturers and vendors to manage the products and samples available for dispensing via the kiosks. The kiosk system is also configured such that the manufacturer or the vendor is provided with the ability to perform analytical reporting on a number of different aspects of data in the database, including users of the system and the sales figures of products.

Systems, methods, and apparatuses, according to one exemplary embodiment, allow downloading software to a user's portable computing device. The software is configured to locate the kiosk. The software allows the manufacturer or the vendor to provide a code to the user via the software, wherein the user inputs the code into the kiosk to obtain a sample. The software also allows for the manufacturer or the vendor to provide a coupon to the user, wherein the user redeems the coupon to purchase a variety of the sample.

Additional features and advantages will be set forth in part in the description that follows, and in part will be obvious from the description, or may be learned by practice of the embodiments disclosed herein. The objects and advantages of the embodiments disclosed herein will be realized and attained by means of the elements and combinations particularly pointed out in the appended claims. It is to be understood that both the foregoing brief summary and the following detailed description are exemplary and explanatory only and are not restrictive of the embodiments disclosed herein or as claimed. The claims have their full ordinary meanings and the descriptions of the embodiments herein are not intended to limit them in any way.

### BRIEF DESCRIPTION OF THE DRAWINGS

The accompanying drawings, which are incorporated in and constitute a part of this specification, illustrate some embodiments disclosed herein, and together with the description, serve to explain principles of the embodiments disclosed herein.

FIG. 1 shows a diagram of an exemplary system environment in accordance with an exemplary embodiment.

FIG. 1A shows a flow diagram for setting up a kiosk system in accordance with an exemplary embodiment.

FIG. 1B shows a flow diagram depicting a system manager's interactions with the kiosk system in accordance with an exemplary embodiment.

FIG. 2 shows a flow diagram of a first manufacturing user's interactions with the kiosk system in accordance an exemplary embodiment.

FIG. 3 shows a flow diagram of a second manufacturing user's interactions with the kiosk system in accordance with an exemplary embodiment.

FIG. 4 shows a flow diagram depicting a system manager's further interactions with the kiosk system in accordance with an exemplary embodiment.

FIG. 5 shows an exemplary kiosk in accordance with an exemplary embodiment.

FIG. 6 shows an exemplary consumer requesting and receiving product samples via interactions with a mobile app and the kiosk system.

FIG. 7 shows an exemplary manufacturer requesting and executing campaign reports from a system manager.

FIGS. 8 and 9 show exemplary screenshots of the reporting and analytic screens of the present invention.

FIG. 10 shows an exemplary screenshot of the various portable computing devices hosting the kiosk app.

### DETAILED DESCRIPTION

The embodiments disclosed herein will now be described by reference to some more detailed embodiments, with occasional reference to the accompanying drawings. These embodiments may, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which these embodiments belong. The terminology used in the description herein is for describing particular embodiments only and is not intended to be limiting of the embodiments. As used in the specification and the appended claims, the singular forms “a,” “an,” and “the” are intended to include the plural forms as well, unless the context clearly indicates otherwise. All publications, patent applications, patents, and other references mentioned herein are incorporated by reference in their entirety.

The following are definitions of exemplary terms used throughout the disclosure. Both singular and plural forms of all terms fall within each meaning:

“Software” or “computer program” as used herein includes, but is not limited to, one or more computer or machine readable and/or executable instructions that cause a computer, microprocessor, logic circuit, or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, an app, a function call, a servlet, an applet, instructions stored in a memory or any other computer readable medium, part of an operating system or other type of executable instructions. It will be appreciated by one of ordinary skill in the art that the form of software is dependent on, for example, requirements of a desired application, the environment it runs on, and/ or the desires of a designer/programmer or the like.

“Mobile Application” or “Mobile App” or “App” as used herein, includes, but is not limited to, applications that run on smart phones, tablet computers, and other mobile devices. The terms “Mobile Application” or “Mobile App” or “App” can be used synonymously with “software”. Mobile applications allow users to connect to services which are traditionally available on the desktop or notebook platforms. Typically, these services access the internet or intranet or cellular or wireless fidelity (Wi-Fi) networks, to access, retrieve, transmit and share data.

“Computer” or “processing unit” as used herein includes, but is not limited to, any programmed or programmable electronic device, microprocessor, logic circuit, that can store, retrieve, and process data.

A “Network” as used herein, includes, but is not limited to, a collection of hardware components and computers or machines interconnected by communication channels that allow sharing of resources and information, including without limitation, the worldwide web or internet. A network can be “wireless” or wired or a combination of a wireless and/or wired communication.

A “Web browser” as used herein, includes, but is not limited to, a software for retrieving and presenting information resources on the World Wide Web. An information resource may be a web page, an image, a video, or any other type of electronic content.

A “Server” as used herein, includes, but is not limited to, a computer or a machine or a device on a network that manages network resources. The general term “Server” may include specific types of servers, such as a File Server (a computer and storage device dedicated to storing files), Print Server (a computer that manages one or more printers), a Network Server (a computer that manages network traffic), and a Database Server (a computer system that processes database queries). Although servers are frequently dedicated to performing only server tasks, certain multiprocessing operating systems allow a server to manage other non-server related resources.

A “Web Server” as used herein, includes, but is not limited to, a server which serves content to a Web browser by loading a file from a disk and serving it across a network to a user's Web browser, typically using a hyper text transfer protocol (HTTP).

“API Files” or “API” or “Application Programming Interface” as used herein, includes, but not limited to, an interface between different software programs or software files, which facilitates the interaction of the different software programs or software files by way of a specific set of rules and specifications.

“Source Code” or “Product Code” as used herein, includes, but not limited to, a textual software code, or a machine code, or notations in graphical software languages, which specify actions to be performed by a machine, which includes, but not limited to, a computer.

“Kiosk” or “Vending Machine” or “Vending Kiosk” or “Kiosk Machine” as used herein includes, but is not limited to, any vending machine which is capable of dispensing products.

### DETAILED DESCRIPTION OF EXEMPLARY EMBODIMENTS

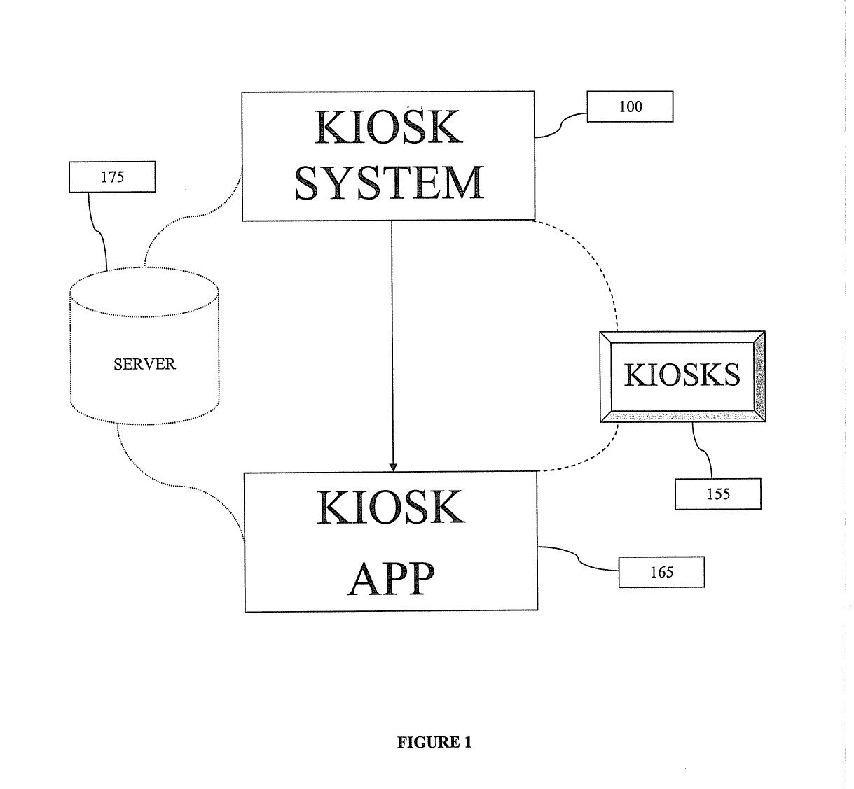

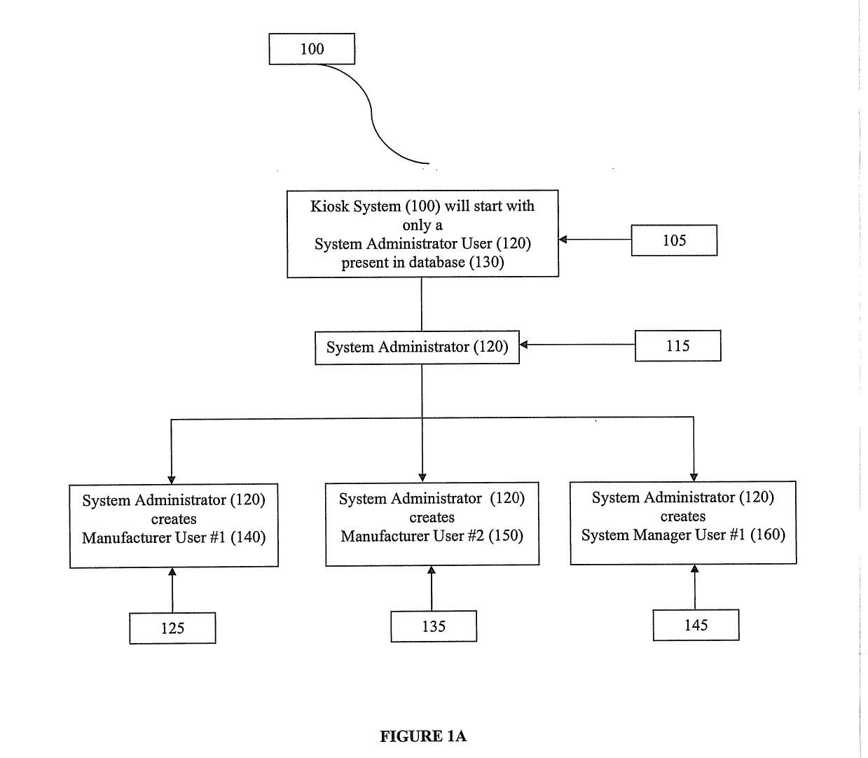

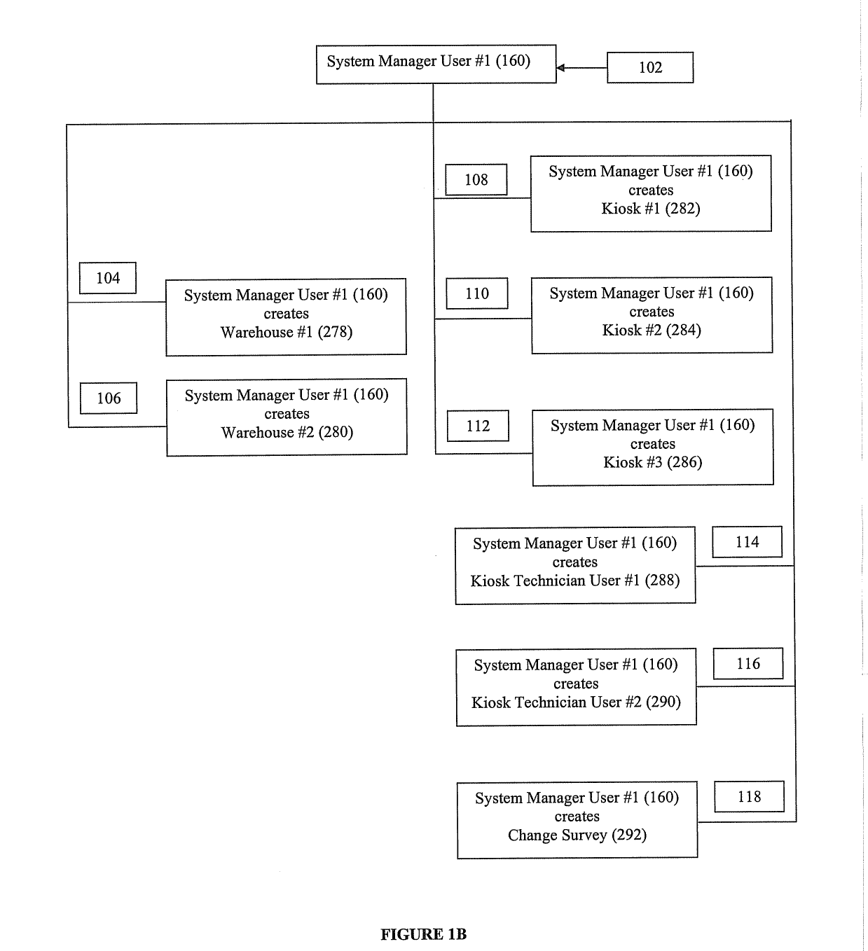

With reference to FIG. 1, the present invention has three modules:
(a) a kiosk system 100, which enables a vendor 101 of the present invention to create manufacturer users and systems users within the system, and manage the interactions between said manufacturers, the system users, and the vendor 101. Specifically, the manufacturer users are manufacturers desirous of distributing their products via the present invention and the vendor 101 is a manager and owner of the present invention, who manages the product sample distribution system for the manufacturers by creating and managing system users within the system.
(b) a kiosk app 165, which enables a consumer to download and utilize an electronic interface to order product samples 110 (not shown), and to perform other interactions with the manufacturers and the vendor 101; and
(c) the kiosks 155, which dispense the product samples 110 as a result of interactions between the kiosk system 100 and the kiosk app 165.

The exemplary embodiments of the present invention will, therefore, be described via a description of the kiosk system 100 and a description of the kiosk app 165, with the implementation of the kiosks 155 being apparent as a result of the description of the kiosk system 100 and the kiosk app 165 and interactions between them.

With further reference to FIG. 1, the kiosk system 100 is housed on a central server 175, typically a web server. The central server 175 may be a single server, or a group of servers 185 (not shown) interconnected via a network 195 (not shown). The kiosk app 165 may be an application which runs as a mobile application on a portable computing device 196 (not shown) or as a browser-based application on a desktop device 197 (not shown), and is in communication with the kiosk system 100 and the central server 175 via the network 195 (not shown). The kiosk app typically houses source code which enables the app to communicate with the kiosk system 100 and the central server 175 via an application programming interface (“API”). The kiosks 155 may be “smart” kiosks which provide an enhanced user experience, usually through providing touch screen interfaces and interactive displays. The kiosk system 100, the kiosk app 165, and the kiosks 155 are in communication with each other via the network 195 (not shown).

### Kiosk System Setup

Now, with particular reference to the drawings, exemplary embodiments of the invention are described below. FIG. 1A depicts a flow diagram for electronically setting the kiosk system 100. The flow diagrams provided herein describe the logic flow or programming flow of the software that comprises exemplary embodiments of the invention. In one embodiment, at step 105, the kiosk system 100 will start with only a “System Administrator User” 120 (“System Administrator”) present in a system database 130. At step 115, the System Administrator 120 initializes the creation of other users in the system 100. At step 125, the System Administrator 120 creates a Manufacturer User #1 (“Manufacturer User 140”). At step 135, the System Administrator 120 creates a Manufacturer User #2 (“Manufacturer User 150”). At step 145, the System Administrator 120 creates a System Manager User #1 (“System Manager 160”).

When any item such as, for example, a “System Administrator” or “Kiosk” is created in the system, unique identification information for identifying the particular item is input into place holders for a particular item by users of the system. For example, with respect to the System Administrator, a unique User ID, password, address, etc. is input and stored in the system. For a “Kiosk” the unique information used to “create” a kiosk in the system may be geographic location, password, site and type.

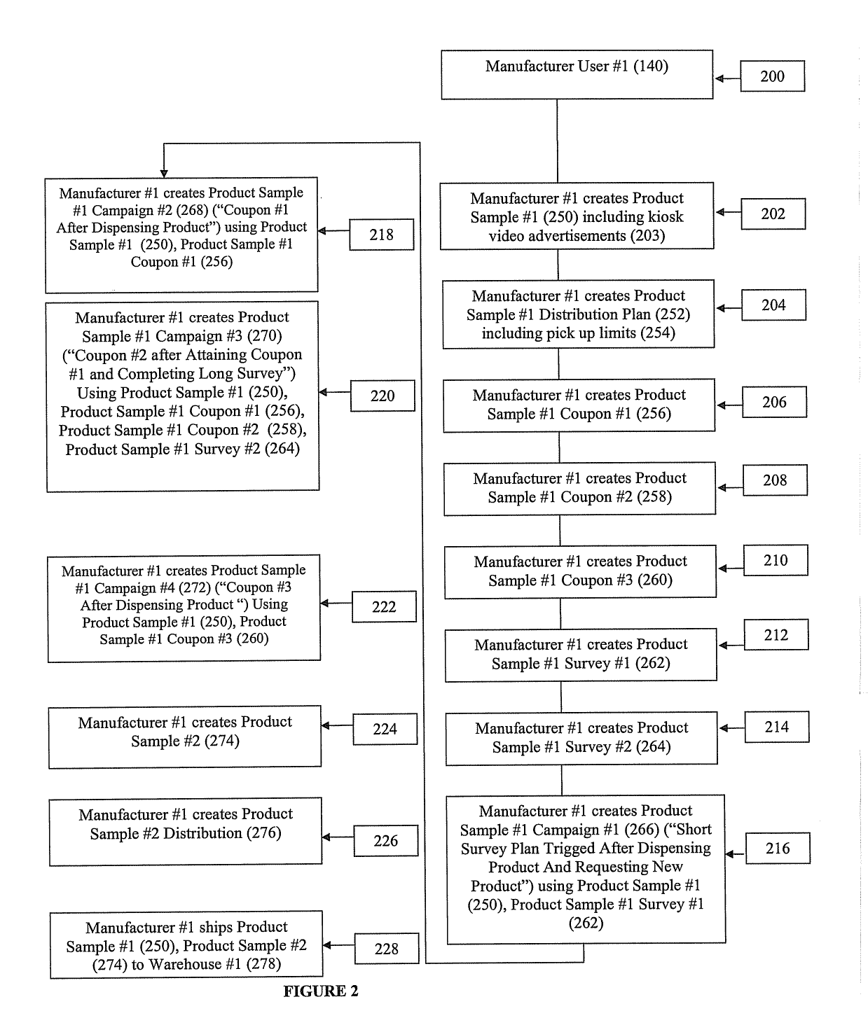

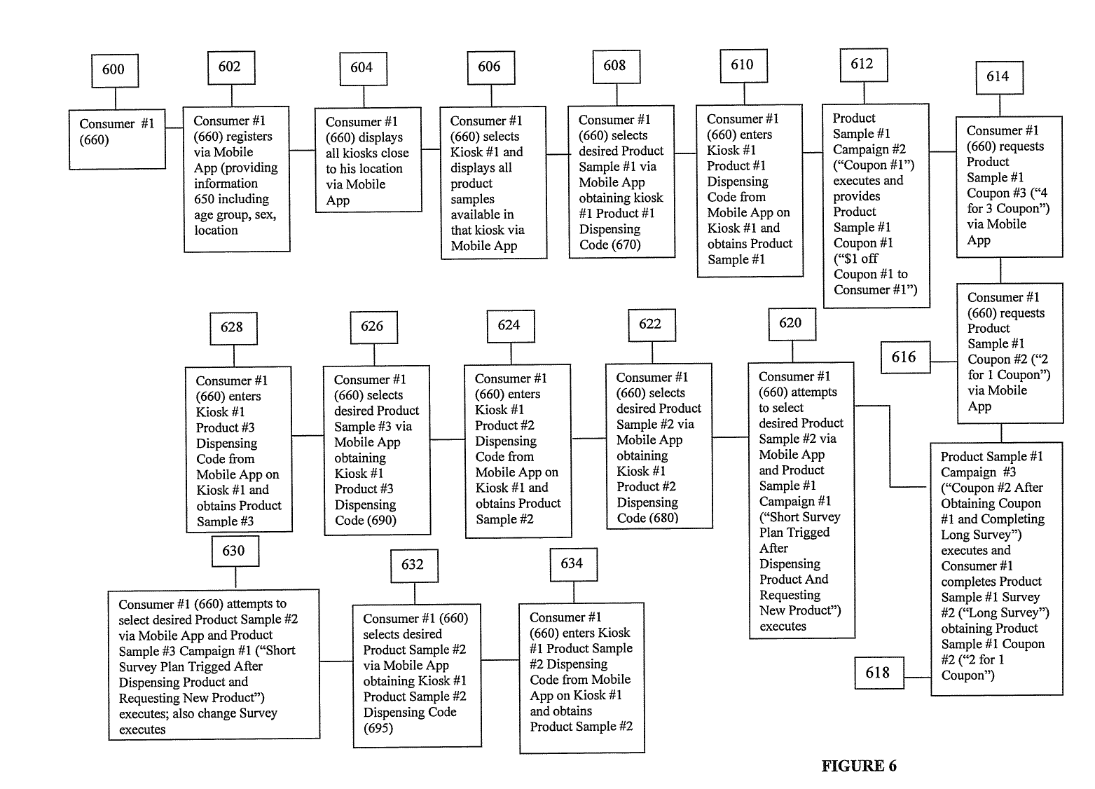

With reference to FIG. 1B, interactions of the system manager 160 are shown. At 104, system manager 160 creates a Warehouse #1 (“Warehouse 278”) to warehouse product samples 110 (additionally described below with reference to FIGS. 2, 3, and 4). At 106 system manager 160 creates a Warehouse #2 (“Warehouse 280”) to warehouse product samples 110. At 108, system manager 160 creates a Kiosk #1 (“Kiosk 282”). At 110, system manager 160 creates a Kiosk #2 (“Kiosk 284”). At 112, system manager 160 creates a Kiosk #3 (“Kiosk 286”). Kiosks 282, 284 and 286 are exemplary kiosks which hold the product samples 110. A kiosk is indicated generally by 155. At 114, system manager 160 creates a Kiosk Technician User #1 (“Kiosk Technician 288”). At 116, system manager 160 creates a Kiosk Technician User #2 (“Kiosk Technician 290”). Kiosk Technicians 288 and 290 are utilized to supply and service kiosks, for instance kiosks 282, 284 and 286. At 118, system manager 160 creates a Change Survey 292 explained further below (with reference to step 630 in FIG. 6).

With reference to FIG. 2, interactions of the Manufacturer User 140 with the system 100 are shown. At 202, Manufacturer User 140 creates a Product Sample #1 (“Product Sample 250”). Further at 202, Manufacturer User 140 creates video advertisements 203 which may be played at a kiosk 155. The video advertisements 203 may be customized depending on the status of the product sample 250. For example, the video advertisements may be tailored differently for the launch of a new product versus distributing a product sample for a product which is categorized as a “slow mover” or a “fast mover.” A “slow moving” product is obviously a product that has sales numbers that are unsatisfactory, while a “fast moving” product is one for which sales are very high and may be difficult to maintain in inventory due to high level and speed of product turnover. Video advertisements 203 may also be capable of multi-lingual display and interactions.

At 204, Manufacturer User 140 creates a Product Sample #1 Distribution Plan 252. The Distribution Plan 252 may be used to tailor the location of the product sample 250, e.g. limiting the product sample 250 to a certain geographic area, or to a certain kiosks) 155 within a geographic area. Further at 204, Manufacturer User 140 creates pick up limits 254 for product sample 250. Pick up limits 254 define sets of time, as part of a reserve program. For example, if the pick up limit 254 is set at 15 minutes, consumers have 15 minutes from the time of requesting a pick up of a product sample 250 to the time the product sample 250 has to be picked up from a kiosk 155, i.e. the product sample 250 is reserved for 15 minutes. Any variation of time limits may be employed at this step, including, but not limited to, 15 minutes, 50 minutes, one day and one week.

At 206, Manufacturer User 140 creates a Product Sample #1 Coupon #1 (“Coupon 256”). Coupon 256 may be any type of coupon. For example, coupon 256 may be a “$1 off coupon” for a product variety of the product sample 250. Coupon, as used in the present invention, comprises among other things, a vehicle provided to the consumer to purchase the product variety at a retail or other establishment. At 208, Manufacturer User 140 creates a Product Sample #1 Coupon #2 (“Coupon 258”). Coupon 258 may be any type of coupon. For example, coupon 258 may be a “2 for 1 coupon” for a product variety of the product sample 250. At 210, Manufacturer User 140 creates a Product Sample #1 Coupon #3 (“Coupon 260”). Coupon 260 may be any type of coupon. For example, coupon 260 may be a “4 for 3 coupon” for a product variety of the product sample 250. The product sample distribution plans and campaign plans can be tailored to “push” or select certain products (or products for samples) that may be “slow movers” or “fast movers” or be based on various inventory levels or sales data of products. The product sample distribution plans and campaign plans can also be tailored to select certain products for sampling in certain geographic locations, or that are “new” product offerings.

At 212, Manufacturer User 140 creates a Product Sample #1 Survey #1 (“Short Survey 262”). At 214, Manufacturer User 140 creates a Product Sample #1 Survey #2 (“Long Survey 264”).

At 216, Manufacturer User 140 creates a Product Sample #1 Campaign #1 (“Campaign 266”) utilizing product sample 250 and short survey 262. Campaign 266 is configured so that, after a consumer requests and obtains product sample 250, if that consumer requests a product sample for a different product in a subsequent request, the consumer is asked to fill out the short survey 262 before receiving the new product sample.

At 218, Manufacturer User 140 creates a Product Sample #1 Campaign #2 (“Campaign 268”) utilizing product sample 250 and coupon 256. Campaign 268 is configured so that, after a consumer requests and obtains product sample 250, the consumer is provided with coupon 256.

At 220, Manufacturer User 140 creates a Product Sample #1 Campaign #3 (“Campaign 270”) utilizing product sample 250, coupon 256, coupon 258, and long survey 264. Campaign 270 is configured so that, after a consumer requests and obtains a product sample 250, and a subsequent coupon 256, if the consumer requests an additional coupon 258, then the consumer is asked to fill out a long survey 264 before receiving the additional coupon 258. The short survey or long survey may ask the consumer multiple questions regarding the consumer's perception and likes or dislikes regarding the product.

At 222, Manufacturer User 140 creates a Product Sample #1 Campaign #4 (“Campaign 272”) utilizing product sample 250 and coupon 260. Campaign 272 is configured similar to campaign 268 in that, after a consumer requests and obtains product sample 250, the consumer is provided with coupon 260.

At 224, Manufacturer User 140 creates a Product Sample #2 (“Product Sample 274”). At 226, Manufacturer User 140 creates a Product Sample #2 Distribution Plan 276. The Distribution Plan 276 may be used to tailor the location of the product sample 274, e.g. limiting the product sample 250 to a certain geographic area, or to a certain kiosk(s) 155 within a geographic area. At 228, Manufacturer User 140 ships product sample 250 and product sample 274 to a Warehouse #1 (“Warehouse 278”).

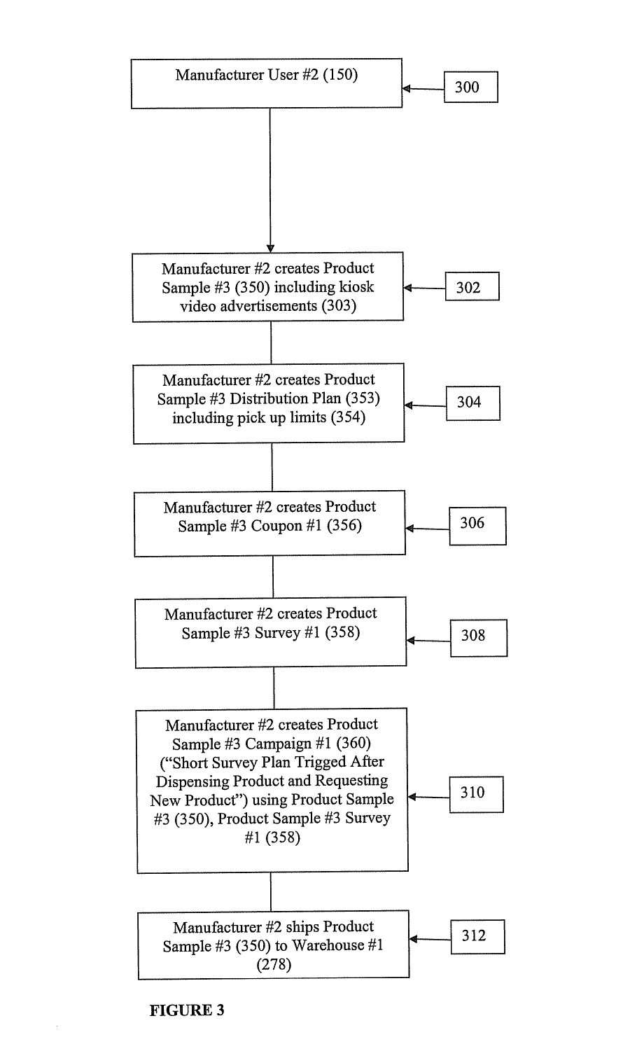

With reference to FIG. 3, interactions of the Manufacturer User 150 with the system 100 are shown. At 302, Manufacturer User 150 creates a Product Sample #3 (“Product Sample 350”). Further at 302, Manufacturer User 150 creates video advertisements 303 which may be played at a kiosk 155. As in step 202 of FIG. 2, the video advertisements 303 may be customized depending on the status of the product sample 350. For example, the video advertisements may be tailored differently for the launch of a new product versus distributing a product sample for a product which is categorized as a slow mover or a fast mover. Video advertisements 303 may also be capable of multi-lingual display and interactions.

At 304, Manufacturer User 150 creates a Product Sample #3 Distribution Plan 352. The Distribution Plan 352 may be used to tailor the location of the product sample 350, e.g. limiting the product sample 350 to a certain geographic area, or to a certain kiosk(s) 155 within a geographic area. Further at 304, Manufacturer User 150 creates pick up limits 354 for product sample 350, as part of a reserve program. As in step 204 of FIG. 2, pick up limits 354 define sets of time. For example, if the pick up limit 354 is set at 15 minutes, consumers have 15 minutes from the time of requesting a pick up of a product sample 350 to the time the product sample 350 has to be picked up from a kiosk 155, i.e. the product sample 350 is reserved for 15 minutes. Any variation of time limits may be employed at this step, including, but not limited to, 15 minutes, 50 minutes, one day and one week.

At 306, Manufacturer User 150 creates a Product Sample #3 Coupon #1 (“Coupon 356”). Coupon 356 may be any type of coupon. For example, coupon 356 may be a “$2 off coupon” for a product variety of the product sample 350.

At 308, Manufacturer User 150 creates a Product Sample #3 Survey #1 (“Short Survey 358”). At 310, Manufacturer User 150 creates a Product Sample #3 Campaign #1 (“Campaign 360”) utilizing product sample 350 and short survey 358. Campaign 360 is configured so that, after a consumer requests and obtains product sample 350, if that consumer requests a different product sample in a subsequent request, the consumer is asked to fill out the short survey 358 before receiving the new product sample. At 312, Manufacturer User 150 ships product sample 350 to warehouse 278.

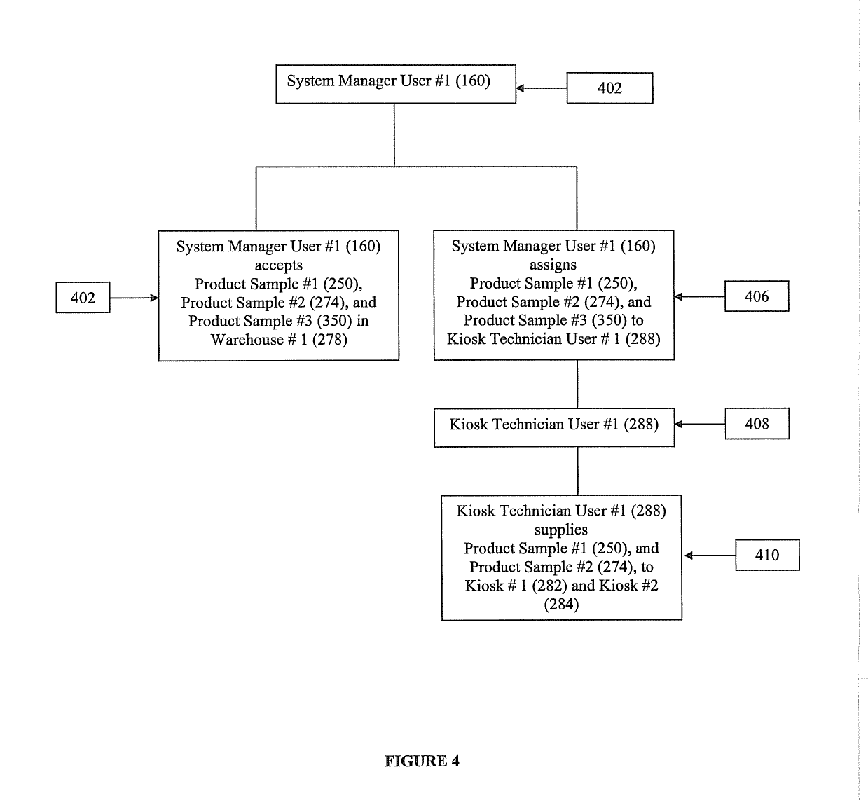

With reference to FIG. 4, the system manager 160, at step 402, accepts the product sample 250 (from step 228 of FIG. 2), product sample 274 (from step 228 of FIG. 2), and product sample 350 (from step 312 of FIG. 3) in the warehouse 278. At step 406, system manager 160 assigns product sample 250, product sample 274, and product sample 350 to kiosk technician 288. The kiosk technician initializes or is created at 408, and supplies product sample 250, and product sample 274, to kiosk 282 and kiosk 284.

### Kiosk

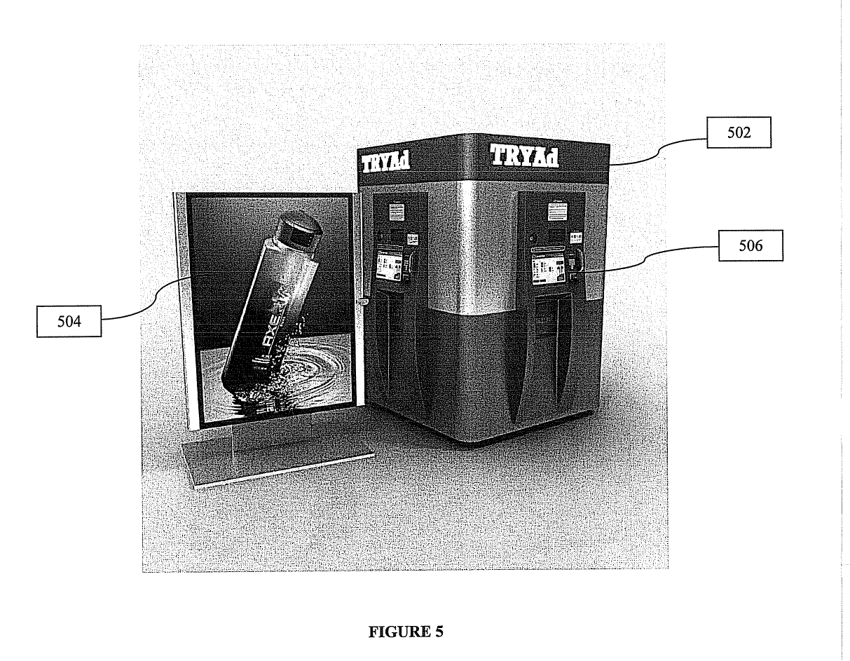

With reference to FIG. 5, an exemplary kiosk 502 of the kiosks 155 is shown. The kiosk 502 is a smart kiosk with an enhanced user experience, through a touch screen interface 506. The kiosk 502 is designed to provide a platform to manufacturers and brand developers and designers to showcase their products. At the same time, kiosk 502 is also designed to provide consumers with an information hub, where information about the products is compiled and presented in an easy interactive format. Further, any of the kiosks 155 provides a device for storing the dispensing product samples to consumers, as described herein.

The kiosk 502 is accompanied by an interactive display 504. Interactive display 504 may be of any variety, a liquid crystal display (LCD) for example. The interactive display 504 is utilized by manufacturers and vendors 101 to furnish consumers with information about products, and to display additional information regarding the manufacturers' and vendors' 101 additional product and service offerings.

Kiosk 502 may be set up as an industry-specific or a brand-specific kiosk. Industry specific kiosks include, for example, a kiosk dedicated to fashion products. Brand specific kiosks include, for example, a kiosk dedicated to Johnson & Johnson® products. Kiosk 502 may contain a variety of different products and samples, including, but not limited to, health products, beverages, snacks, food items, coffee/tea, entertainment products, electronics, and beauty products. Kiosk 502 may be set up at a variety of locations, including but not limited to gas stations, airports, malls, grocery stores, department stores, schools and universities, hotels, convention centers, casinos, resorts, amusement parks, cruise ships, movie theaters and transport stations.

### Kiosk App Setup

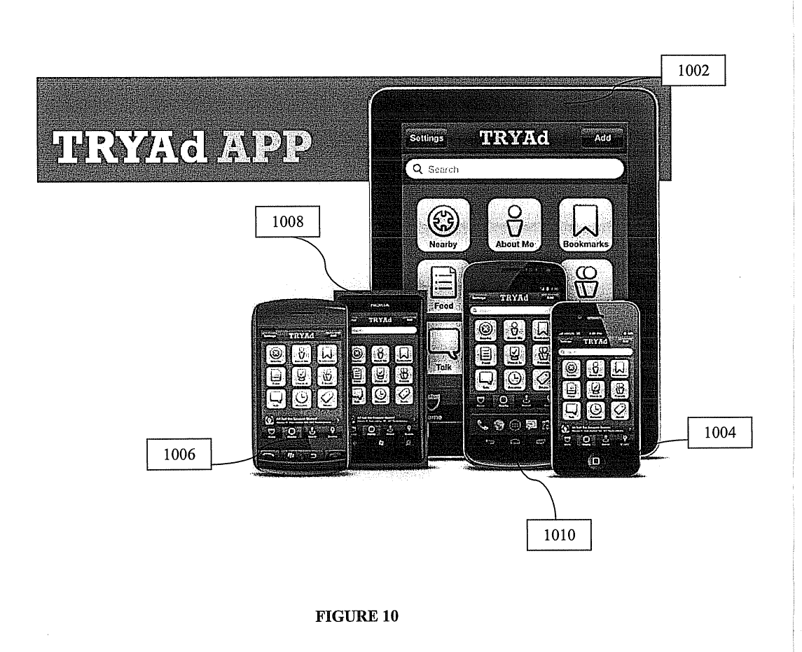

The kiosk app 165 (with reference to FIG. 1) is a vendor 101 owned application which is delivered to the consumers on their portable computing devices through popular portable computing platforms such as WebOS®, Android®, iOS® and Blackberry®. An screenshot showing several portable computing devices hosting an exemplary kiosk app 165 is shown in FIG. 10. With reference to FIG. 10, portable computing devices 1002, 1004, 1006, 1008, 1010 all show an embodiment of the kiosk app 165, called a TRYAd app. The kiosk app 165 may also be delivered to the consumers on their desktop or non-portable computing devices through desktop computing platforms such as Windows® and Linux®. The kiosk app 165 interacts with the kiosk system 100 to deliver product samples 110 to consumers.

The kiosk app 165 serves a number of purposes. For instance, the kiosk app 165 allows a consumer to request product sample dispensation codes for the purpose of obtaining product samples 110. The kiosk app 165 allows the consumer to reserve product samples 110 at certain kiosk locations 155. The kiosk app 165 also allows a consumer to access a searchable interface to view current, past or future promotions/coupons within several product or sample categories, to ascertain what manufacturer's products or samples are available at what kiosk locations 155, to ascertain the available stock-keeping units (SKUs) left in the inventory of the system database 103, to ascertain alternative kiosk locations which hold a particular SKU if said SKU is not available at a primary kiosk location, to ascertain the estimated time of arrival of a particular SKU at a particular kiosk 155, and to receive coupons matched to the consumer's geographic location. The kiosk app 165 may also be set up to interact with social networking platforms such as Facebook® and Twitter®. Utilizing such social networking platforms, the kiosk app 165 may be configured to “rank” its consumers based on their purchasing patterns, as compared with their social networking contacts. The kiosk app 165 allows manufacturers and vendors 101 to send notifications to the consumer. Said notifications may be for any purpose, including, but not limited to, advertisements, promotional emails, promotional sweepstakes, new product offerings, new sample offerings, coupon offerings, reminders, product and/or sample availability, and kiosk locations.

With reference to FIG. 6, a consumer 660 downloads the kiosk app 165 at step 602. The kiosk app may be housed either on the central server 175 or at a third-party location managed by a third party provider, e.g. Apple's App Store®. In the case of the kiosk app 165 being available to the consumers via desktop computing platform, the kiosk app 165 may be available as an application or software program enabled by a web-browser. In such case, the kiosk app 165 may be housed on the central server 175 or at another location managed by the vendor 101 or a third party. In either case, the kiosk app 165 is in network communication with the kiosk system 100 and the kiosks 155 through the network 195.

With further reference to step 602 in FIG. 6, upon downloading the kiosk app 165, the consumer 660 registers their personal information 650 with the kiosk system 100. The personal information 650 may include age, gender, location and product preferences. At step 604, the consumer 660 displays a list of all kiosks 155 located in a geographical vicinity of the consumer 660 location. The geographical vicinity is pre-determined by the kiosk system 100 or the kiosk app 165, or both, and may include distances ranging from within a few feet of the consumer 660 location to any arbitrary or pre-selected distance within the consumer 660 location. The kiosk app 165 may also provide the consumer with driving directions to one or more kiosk locations.

As explained above with reference to FIG. 1B, the number of available kiosks within the kiosk system 100 is determined by the system manager 160. System manager 160 sets up the total number of kiosks 155 available in system 100 at steps 108, 110 and 112 in FIG. 1B. It is understood to one of ordinary skill in the art that the system manager 160 may set up any number of kiosks 155 which may be available to the system 100. For each kiosk 155 set up by the system manager 160, a designated kiosk technician (e.g. kiosk technician 288) is responsible for supplying the product samples 110 to said kiosk 155. In one example, the kiosk technician 288 is responsible for supplying product samples 250 and 274 to kiosk 282. In doing so, the kiosk technician 288 procures the product samples 250 and 274 for kiosk 155 from warehouse 278.

At step 606, the consumer 660 selects a particular kiosk location, kiosk 282 for example. Upon selection of kiosk 282, the kiosk app 165 displays a list of all product samples 110 available at the kiosk 282 location. The list of available product samples 110 is determined by the kiosk system 100. For example, as explained with reference to FIG. 2, the manufacturer user 140 sets up a distribution plan 252 by way of which the product sample 250 is assigned to certain kiosks 155. Similarly, manufacturer user 140 sets up a distribution plan 276 for product sample 274. With reference to FIG. 3, manufacturer user 150 sets up a distribution plan 353 for product sample 350.

At step 608, consumer 660 selects product sample 250 via the kiosk app 165. At this step, consumer 660 is provided with a product sample dispensing code 670. Dispensing code 670, and the other dispensing codes described below, may include, but not limited to, a unique key of any known type of electronic code such as an alphanumeric code, a bar code, a quick response (QR) code, a symbol, randomly-generated keys/codes, and any combination thereof. As part of a reserve program, consumer 660 is bound by the pick up time limits set up in the kiosk system 100 as it relates to the product sample 250. As explained earlier with reference to FIG. 2, manufacturer user 140 sets up a pick up limit 254 for product sample 250. Consumer 660 is required to redeem the product sample 250 via the product sample dispensing code 670 at kiosk 282 within the time limit (reserve program time) set up by pick up limit 254. The pick up limit 254 may be any length of time, sixty minutes for example. In the event that the consumer 660 fails to redeem the product sample 250 within the prescribed pick up limit 254, the vendor 101 or the manufacturer user 140 may set up penalties. For example, for a consumer who fails to pick up a product sample 155 within the previously set pick up limit, the vendor 101 or the manufacturer user 140 may reduce the amount of time available in the pick up limit or future pick up limits, for example, change the reserve program time from sixty minutes to 15 minutes. Also, if a consumer fails to redeem a product sample from a kiosk location, the same product sample may then be made available to other consumers requesting said product sample from the same kiosk location.

At step 610, consumer 660 enters product sample dispensing code 670 at kiosk 282 and obtains the product sample 250 via the kiosk 282. When consumer 660 arrives at kiosk 282, consumer 660 may be presented with various video advertisements. The video advertisements may be set up by the vendor 101, or by the manufacturer user 140. For example, with reference to FIG. 2, at step 202, manufacturer user 140 set up kiosk video advertisements 203 with reference to product sample 250. Therefore, when consumer 660 arrives at kiosk 282 to pick up product sample 250, consumer 660 may be presented with the kiosk video advertisements 203. Similarly, as exemplified in FIG. 6, had the consumer 660 chosen product sample 350, consumer 660 may have been presented with specific kiosk video advertisements 303 set up by manufacturer user 150 at step 302 in FIG. 3 and designed for consumers of product sample 350.

It will be understood to one of ordinary skill in the art that the consumer 660 may request multiple product samples 110 at any given time. The kiosk system 100 or the kiosk app 165 may be configured to pre-set a minimum and a maximum number of product samples 110 which may be dispensed to consumer 660 at any given time. Further, the product samples 155 available to consumer 660 may be limited by the product sample campaigns set up by the manufacturer users.

With further reference to FIG. 6, at step 612, consumer 660 is provided with coupon 256 after the product sample 250 is dispensed. It may be recalled that the manufacturer users set up product sample campaigns as part of the kiosk system 100 set up. With reference to FIG. 2, manufacturer user 140 set up campaign 268 at step 218. Campaign 268 provides that a coupon 256 is generated when the product sample 250 is dispensed to a consumer. Therefore, when consumer 660 requests and receives product sample 250 from kiosk 282, campaign 268 executes and provides consumer 660 with coupon 256. At step 614, consumer 660 requests an additional coupon (coupon 260) via the kiosk app 165. At this step, campaign 272 is executed. Campaign 272 was set up by manufacturer user 140 at step 222 in FIG. 2, to be executed when a consumer requests coupon 260 after dispensing product sample 250. Therefore, coupon 260 is provided to consumer 660 upon request at 614.

At step 616, consumer 660 requests coupon 258. Therefore, at step 618, campaign 270 executes. Campaign 270 was set up by manufacturer user 140 at step 220 in FIG. 2, to be executed when a consumer requests coupon 258 after dispensing product sample 250 and coupon 256. According to the terms of campaign 270, consumer 660 is presented with survey 265 at this step. Consumer 660 fills out and submits survey 265 and obtains the requested coupon 258.

At step 620, consumer 660 requests a different product sample (274) via the kiosk app 165. At this step, campaign 266 executes. Campaign 266 was set up by manufacturer user 140 at step 216 in FIG. 2, to be executed when a consumer requests a new product after dispensing product sample 250. According to the terms of campaign 266, consumer 660 is presented with short survey 262. Consumer 660 fills out and submits short survey 262 at this step. At step 622, consumer 660 selects the desired product sample 274 and obtains a product sample dispensing code 680. At step 624, consumer 660 enters product sample dispensing code 680 at kiosk 282 and obtains the product sample 274 via the kiosk 282.

At step 626, consumer 660 requests a product sample 350 via the kiosk app 165 and obtains a product sample dispensing code 690. At step 628, consumer 660 enters product sample dispensing code 690 at kiosk 282 and obtains the product sample 350 via the kiosk 282. When consumer 660 arrives at kiosk 282, consumer 660 may be presented with various video advertisements. The video advertisements may be set up by the vendor 101, or by the manufacturer user 140. For example, with reference to FIG. 3, at step 302, manufacturer user 150 set up kiosk video advertisements 303 with reference to product sample 350. Therefore, when consumer 660 arrives at kiosk 282 to pick up product sample 350, consumer 660 may be presented with the kiosk video advertisements 303.

At step 630, consumer 660 attempts to select product sample 274 via the kiosk app 165. At this step, campaign 360 executes. Campaign 360 was set up by manufacturer user 150 at step 310 in FIG. 3, to be executed when a consumer requests a new product after dispensing product sample 350. According to the terms of campaign 360, consumer 660 is presented with survey 358. Consumer 660 fills out and submits survey 358 at this step. Consumer 660 is also presented with a “change” survey 292, which is created by the system manager 160 (See FIG. 1A, step 118) to track a consumer changing their sample or coupon request from a first product to a second product. This change survey may inquire of the consumer, for example, as to the reasons for making a sample change or switch. Consumer 660 fills out and submits change survey 292 at this step. At step 632, consumer 660 selects the desired product sample 350 and obtains a product sample dispensing code 695. At step 634, consumer 660 enters product sample dispensing code 695 at kiosk 282 and obtains the product sample 350 via the kiosk 282.

It will be understood by those skilled in the art that the campaign designs explained with reference to FIGS. 2, 3 and 6 above are exemplary and may be modified and executed in a variety of different forms. Further, a manufacturer user may choose to combine campaigns or to eliminate campaigns all together for a given product sample. The order of the campaigns is not dispositive and may be set up in any order by the manufacturer user or the vendor 101. Further, any number of campaigns, kiosks, samples, or products may be implemented in the system.

### Reporting

The kiosk system 100 provides manufacturers not only with the ability to customize and tailor their product sample offerings, but to also obtain important reporting and trending data on the product samples 110 and any other campaigns/information which the manufacturer might choose to track. The kiosk system 100 may be configured to track information such as the time when consumers shop, the frequency of logins, the place of purchase, the gender, the age, categories of products, brands, mobile platforms etc. Such reporting capabilities would not only allow the manufacturers to obtain in depth direct feedback, but to also use such feedback to tailor their communications with the consumers, and to tailor the course of their future product offerings. For instance, once direct analytical information is gathered on a particular consumer, targeted offers customized to that particular consumer can be sent directly via the kiosk app 165. Further, manufacturers would utilize such data to perfect the product quality and to broaden the appeal of their products.

In-depth reporting in the kiosk system 100 also allows manufacturers to obtain immediate knowledge of their campaigns in real time. Further, manufacturers and vendors 101 may utilize the reporting features of the kiosk system 100, in conjunction with the kiosk app 165 and data from the kiosks 155 to track which kiosks 155 need replenishment of products and/or samples. An exemplary reporting scenario is explained below.

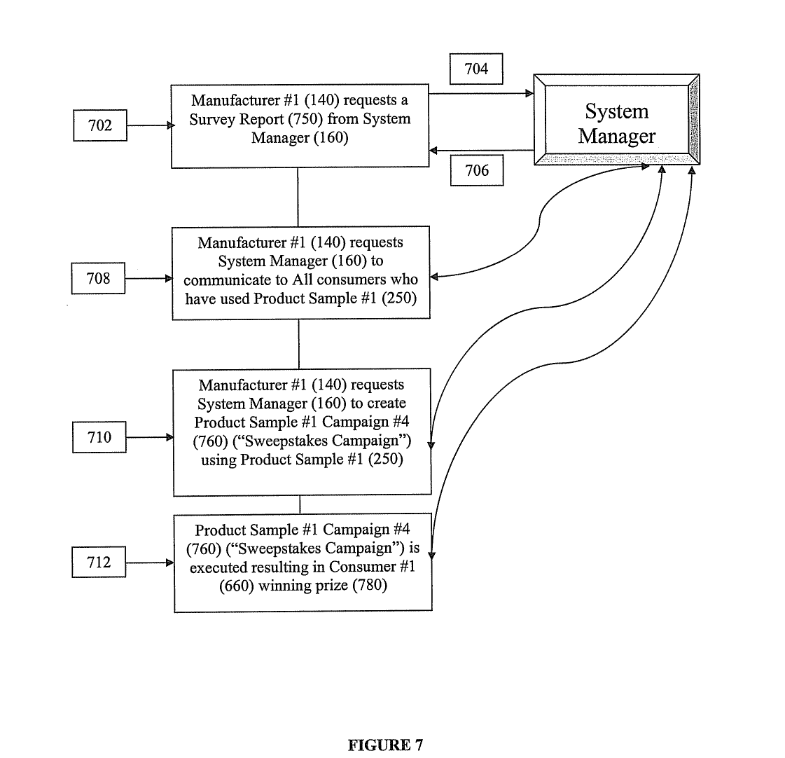

With reference to FIG. 7, at step 702, manufacturer 140 requests a “survey” report 750 from the system manager 160. The report request, at step 704, is then communicated to the system manager 160, which then responds back with the requested report at step 706. At step 708, manufacturer 140 requests the system manager 160 to communicate to all consumers who have used product sample 250. In furtherance of this request, at step 710, manufacturer 140 requests the system manger 160 to create a product sample 250 campaign, campaign 760, which is a sweepstakes format, with a prize 780. At step 712, the system manager 160 creates product sample campaign 760, which is executed, resulting in consumer 660 winning the campaign prize 780 for participating in campaign 760.

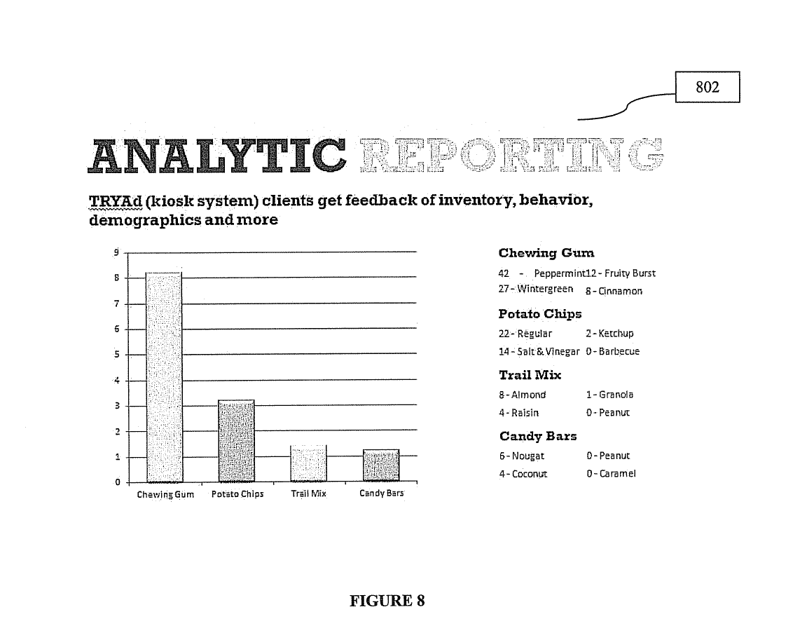

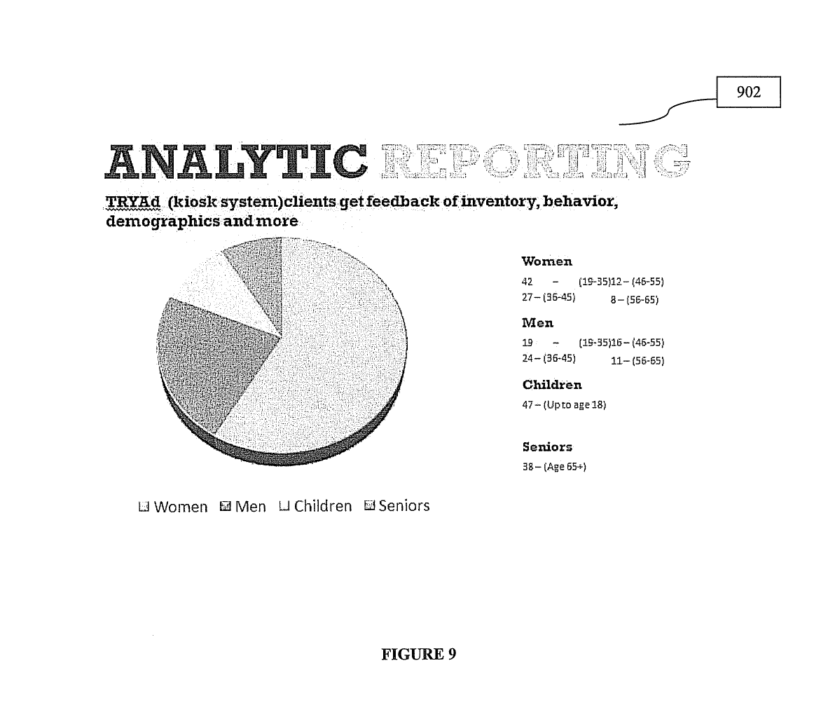

FIGS. 8 and 9 show exemplary screenshots of various reports, in accordance with the embodiments of the present invention. For instance, screen 802 of FIG. 8 shows an exemplary analytic report comprising of sales data of several manufacturer products. Similarly, screen 902 of FIG. 9 shows an exemplary analytic report comprising of consumer demographic information.

The above description of specific embodiments has been given by way of example. From the disclosure given, those skilled in the art will not only understand the general inventive concepts and attendant advantages, but will also find apparent various changes and modifications to the structures and methods disclosed. For example, the general inventive concepts are not typically limited to the consumer requesting only product samples via the kiosk app. Thus, for example, alternative uses of the app, for completing surveys, for interacting with the manufacturers and vendors, for participating in social networking websites, are within the spirit and scope of the general inventive concepts. As a further example, the general inventive concepts are not typically limited to providing surveys only upon a consumer requesting a coupon or a product sample (or engaging in some other customer-initiated activity). Surveys may be incorporated as part of the kiosk system 100 and kiosk app 165 in other ways. For instance, consumers may be provided with brief surveys after they had a chance to redeem a coupon, typically thirty days after the redemption occurs. It is sought, therefore, to cover all such changes and modifications as fall within the spirit and scope of the general inventive concepts, as described and claimed herein, and equivalents thereof.

1. A method of distributing samples, comprising:
providing a kiosk, wherein the kiosk is used to distribute samples;
providing downloadable software to a portable computing device, wherein the software is configured to locate the kiosk;
providing a code to a user via the software, wherein the user inputs the code into the kiosk to obtain a sample; and
providing a coupon to the user, wherein the user redeems the coupon to purchase a variety of the sample.

2. A method of distributing samples of claim 1 includes the additional step of:
determining the coupon to provide to the user.

3. The method of claim 2 wherein the step of determining the coupon to provide to the user is based on sales data of the variety of the sample.

4. The method of claim 2 wherein the step of determining the coupon to provide to the user is based on the user's activity within the software.

5. The method of claim 2 wherein the step of determining the coupon to provide to the user is based on inventory levels of the variety of the sample.

6. The method of claim 2 wherein the step of determining the coupon to provide to the user is based on novelty of the variety of the sample.

7. A method of distributing samples of claim 1 includes the additional step of:
sending a notification to the user.

8. A method of distributing samples, comprising:
providing a kiosk, wherein the kiosk is used to distribute samples;
providing downloadable software to a portable computing device, wherein the software is configured to locate the kiosk;
providing a code to a user via the software, wherein the user inputs the code into the kiosk to obtain a sample;
providing a coupon to the user, wherein the user redeems the coupon to purchase a variety of the sample; and
executing a survey of the user related to the sample.

9. The method of distributing samples in claim 8 wherein the step of providing a survey being triggered before the user obtains the sample.

10. The method of distributing samples in claim 8 wherein the step of providing a survey being triggered after the user obtains the sample.

11. The method of distributing samples in claim 8 wherein the step of providing a survey being triggered after the user obtains the sample and requests a second sample of another product variety.

12. The method of distributing samples in claim 8 wherein the step of providing a survey being triggered after the user obtains the sample, obtains and redeems a coupon, and requests a second coupon of the same product variety.

13. The method of distributing samples in claim 8 wherein the step of providing a survey includes providing a survey created by a system manager.

14. The method of distributing samples in claim 8 wherein the step of providing a survey includes providing a survey created by a manufacturer.

15. The method of distributing samples in claim 8 wherein the step of providing a survey includes providing a survey created by a vendor.

16. The method of distributing samples of claim 8 includes the additional step of:
setting a reserve time, wherein the user must input the code into the kiosk and obtain the sample before the expiration of the reserve time.

17. The method of distributing samples in claim 8 wherein the step of providing downloadable software further includes providing driving directions to the kiosk.

18. The method of distributing samples of claim 8 includes the additional step of providing an analytical report to a manufacturer.

19. The method of distributing samples of claim 8 includes the additional step of:
providing an analytical report to a vendor.

20. A sample distribution system, comprising:
a kiosk having samples;
software configured to locate the kiosk through the use of a portable computing device;
a code for obtaining a sample from the kiosk delivered to a user's portable computing device after downloading the software; and
a coupon to purchase a variety of the product sample issued by the kiosk.
